(19) United States
(12) Patent Application Publication
(10) Pub. No.: US 2003/0179058 A1
(43) Pub. Date: Sep. 25, 2003

(54) System and method for routing input signals using single pole single throw and single pole double throw latching micro-magnetic switches

(75) Inventors: Rimantas Vaitkus, Paradise Valley, AZ (US); Jun Shen, Phoenix, AZ (US); Charles Wheeler, Paradise Valley, AZ (US); Meichun Ruan, Tempe, AZ (US); Gordon Tam, Gilbert, AZ (US)

Correspondence Address: STERNE, KESSLER, GOLDSTEIN & FOX PLLC, 1100 NEW YORK AVENUE, N.W., WASHINGTON, DC, 20005, US

(73) Assignee: Microlab, Inc.

(21) Appl. No.: 10/347,526

(22) Filed: Jan. 21, 2003

Related U.S. Application Data
(60) Provisional application No. 60/349,254, filed on Jan. 18, 2002.

(51) Int. Cl. H01H 51/22

(52) U.S. Cl. 335/78

(57) ABSTRACT

A system and method are used to route input signals from an input node to N output nodes. The system includes an input section that receives input signals, an output section that transmits output signals based on the input signals, and a switching section. The switching section includes switches that control transmission of the input signals from the input section to the output section. The switches can be latching micro-magnetic switches that include a magnet proximate to a substrate, a cantilever coupled to the substrate and positioned proximate to the magnet, the cantilever coupled to a magnetic material, and a conductor coupled to the substrate, the conductor conducting a current that induces a first torque in the cantilever

### CROSS-REFERENCE TO RELATED APPLICATIONS

This application claims benefit under 35 U.S.C. 119(e) to U.S. Prov. Pat. App. No. 60/349,254, filed Jan. 18, 2002, which is incorporated by reference herein in its entirety.

### BACKGROUND OF THE INVENTION

1. Field of the Invention

The present invention relates to switches. More specifically, the present invention relates to a single-pole-N-throw (SPNT) switch using single-pole-single-throw (SPST) latching micro-magnetic switches and/or single-pole-double-throw (SPDT) latching micro-magnetic switches.

2. Background Art

Switches are typically electrically controlled two-state devices that open and close contacts to effect operation of devices in an electrical or optical circuit. Relays, for example, typically function as switches that activate or de-activate portions of electrical, optical or other devices. Relays are commonly used in many applications including telecommunications, radio frequency (RF) communications, portable electronics, consumer and industrial electronics, aerospace, and other systems. More recently, optical switches (also referred to as “optical relays” or simply “relays” herein) have been used to switch optical signals (such as those in optical communication systems) from one path to another.

Although the earliest relays were mechanical or solid-state devices, recent developments in micro-electro-mechanical systems (MEMS) technologies and microelectronics manufacturing have made micro-electrostatic and micro-magnetic relays possible. Such micro-magnetic relays typically include an electromagnet that energizes an armature to make or break an electrical contact. When the magnet is de-energized, a spring or other mechanical force typically restores the armature to a quiescent position. Such relays typically exhibit a number of marked disadvantages, however, in that they generally exhibit only a single stable output (i.e., the quiescent state) and they are not latching (i.e., they do not retain a constant output as power is removed from the relay). Moreover, the spring required by conventional micro-magnetic relays may degrade or break over time.

Non-latching micro-magnetic relays are known. The relay includes a permanent magnet and an electromagnet for generating a magnetic field that intermittently opposes the field generated by the permanent magnet. The relay must consume power in the electromagnet to maintain at least one of the output states. Moreover, the power required to generate the opposing field would be significant, thus making the relay less desirable for use in space, portable electronics, and other applications that demand low power consumption.

An M-in/N-out system (e.g., an M-in/N-out switch matrix) to route signals that utilizes SPST or SPDT bi-stable, latching switches that do not require power to hold the states is desired. Such switches should also be reliable, simple in design, low-cost and easy to manufacture, and should be useful in optical and/or electrical environments.

### BRIEF SUMMARY OF THE INVENTION

Embodiments of the present invention provide a system including an input section that receives input signals, an output section that transmits output signals based on the input signals, and a switching section. The switching section includes switches that control transmission of the input signals from the input section to the output section. The switches include a magnet proximate to a substrate, a cantilever coupled to the substrate and positioned proximate to the magnet, the cantilever coupled to a magnetic material, and a conductor coupled to the substrate, the conductor conducting a current that induces a first torque in the cantilever.

Other embodiments of the present invention provide a method including receiving an input signal and routing the input signal to output sections. The routing is performed using latching micro-magnetic switches having a cantilever. The cantilever moves between a first state and a second state based on a first torque generated by a first magnetic field produced by a magnet and a second torque generated by a second magnetic field produced by current flowing through a conductor.

Another embodiment of the present invention provides a system and method that support a cantilever and produce a first magnetic field that is substantially perpendicular to a longitudinal axis of the cantilever. The system and method provide a switch that produces a second magnetic field. The system and method provide a device on the cantilever that causes the cantilever, while in a presence of the first magnetic field, to be in one of a normally on or normally off state. The system and method activate the switch to switch the state of the cantilever.

In various embodiments, the switches can be single-pole-single-throw (SPST) latching micro-magnetic switches and/or single-pole-double-throw (SPDT) latching micro-magnetic switches.

The system and method of the present invention can be used in many of products including household and industrial appliances, consumer electronics, military hardware, medical devices and vehicles of all types, just to name a few broad categories of goods. The system and method of the present invention can the advantages of compactness, simplicity of fabrication, and good performance at high frequencies.

Further embodiments, features, and advantages of the present inventions, as well as the structure and operation of the various embodiments of the present invention, are described in detail below with reference to the accompanying drawings.

### BRIEF DESCRIPTION OF THE FIGURES

The above and other features and advantages of the present invention are hereinafter described in the following detailed description of illustrative embodiments to be read in conjunction with the accompanying drawing figures.

FIGS. 1A and 1B are side and top views, respectively, of a latching micro-magnetic switch according to embodiments of the present invention.

FIG. 2 illustrates a hinged-type cantilever and a one-end-fixed cantilever, respectively, according to embodiments of the present invention.

FIG. 3 illustrates a cantilever body having a magnetic moment m in a magnetic field Ho according to embodiments of the present invention.

FIGS. 4-8 illustrate single pole multiple throw switches according to the embodiments of the present invention.

### DETAILED DESCRIPTION OF THE INVENTION

It should be appreciated that the particular implementations shown and described herein are examples of the invention and are not intended to otherwise limit the scope of the present invention in any way. Indeed, for the sake of brevity, conventional electronics, manufacturing, MEMS technologies and other functional aspects of the systems (and components of the individual operating components of the systems) may not be described in detail herein. Furthermore, for purposes of brevity, the invention is frequently described herein as pertaining to a micro-electronically-machined relay for use in electrical or electronic systems. It should be appreciated that many other manufacturing techniques could be used to create the relays described herein, and that the techniques described herein could be used in mechanical relays, optical relays, or any other switching device. Further, the techniques would be suitable for application in electrical systems, optical systems, consumer electronics, industrial electronics, wireless systems, space applications, or any other application. Moreover, it should be understood that the spatial descriptions (e.g. “above”, “below”, “up”, “down”, etc.) made herein are for purposes of illustration only, and that practical latching relays may be spatially arranged in any orientation or manner. Arrays of these relays can also be formed by connecting them in appropriate ways and with appropriate devices.

Principle of Operation

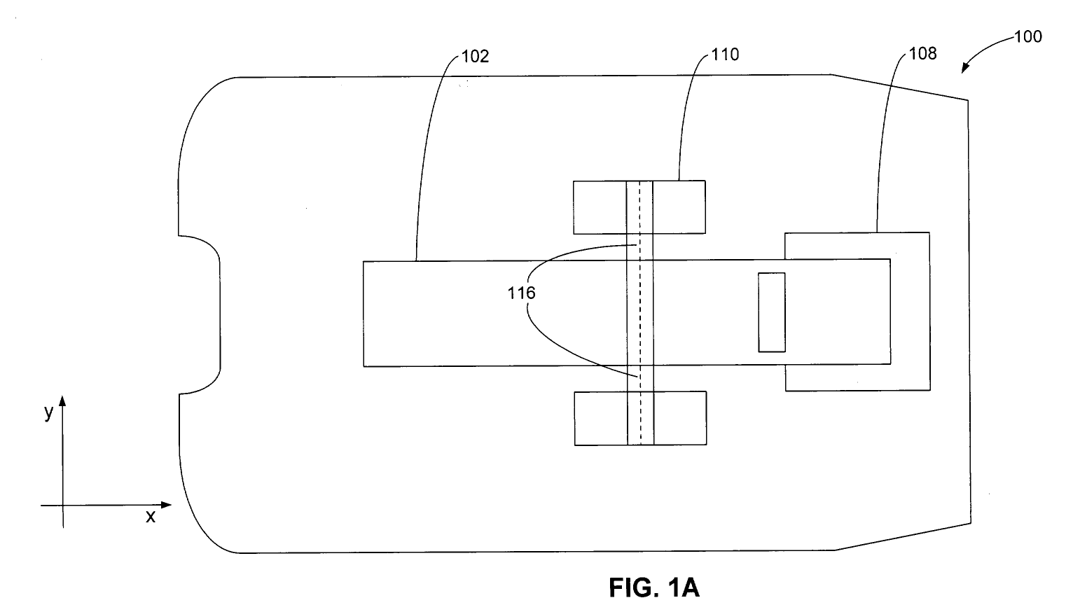

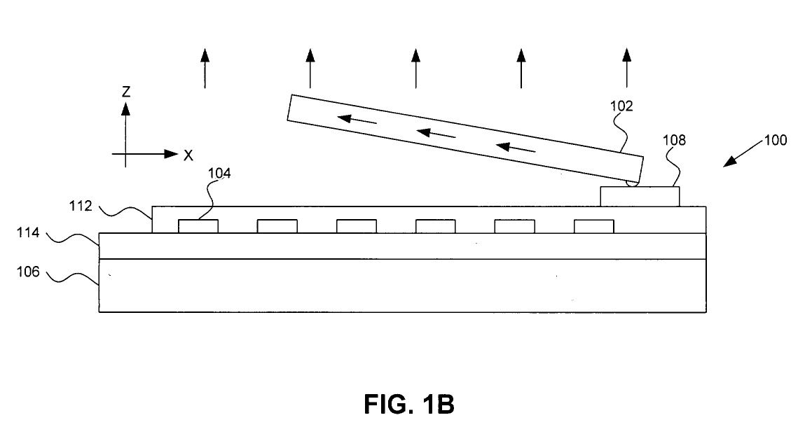

FIGS. 1A and 1B are top and side views, respectively, showing a device (e.g., a switch) 100 according to embodiments of the present invention. Device 100 can include a cantilever 102, a conductor (e.g., a planar coil) 104, a magnet (e.g., a permanent magnet) 106, and electrical contacts 108 and 110. Cantilever 102 can be a multi-layer composite including, for example, a soft magnetic material (e.g., nickel iron (NiFe) permalloy) on its top surface and a highly conductive material (e.g., gold (Au)) on its bottom surface. It is to be appreciated that cantilever 102 can include additional layers and/or can have various shapes. Coil 104 can be formed in a insulative layer 112 on a substrate 114. In some embodiments, the cantilever 102 can be supported by lateral torsion flexures 116. Flexures 116 can be electrically conductive and form part of the conduction path when switch 100 is closed.

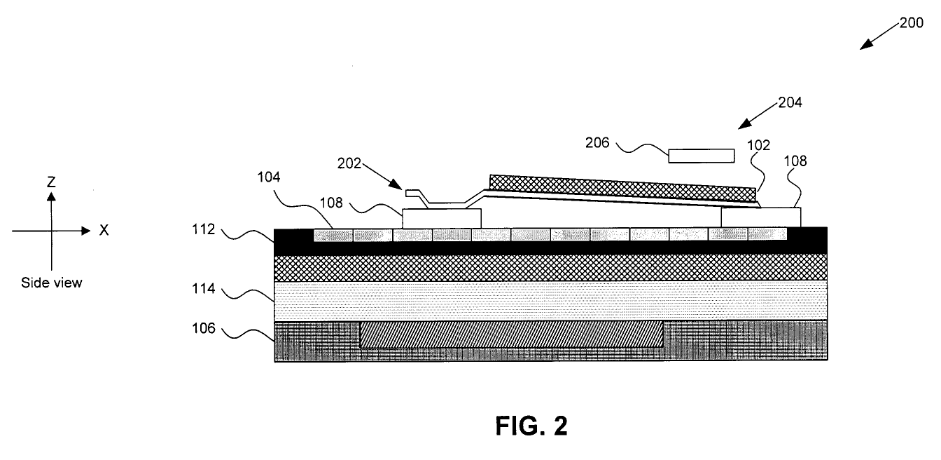

FIG. 2 shows a side view of a switch 200 according to embodiments of the present invention. In this embodiment, cantilever 102 can be fixed at a first end (e.g., a right side of cantilever 102 in this view of switch 200) 202, while a second end 204 remains free to move (e.g., deflect). First end 202 can be deflected up or down by applying a temporary current through coil 104. When first end 202 is in the “down” position, cantilever 102 makes electrical contact with conductor 108. This turns the switch “on”(also called the “closed” state). Hence, when first end 202 is “up,” the switch is “off”(also called the “open” state). In some embodiments, a stopping device 206 can be used to limit the upward deflection of cantilever 102. Permanent magnet 106 can be used to hold cantilever 102 in either the “up” or the “down” position after switching, making the device a latching relay. A current can be passed through coil 104 (e.g., when coil 104 is energized) during a brief period of time to transition switch 200 between the two states.

(i) Method to Produce Bi-stability

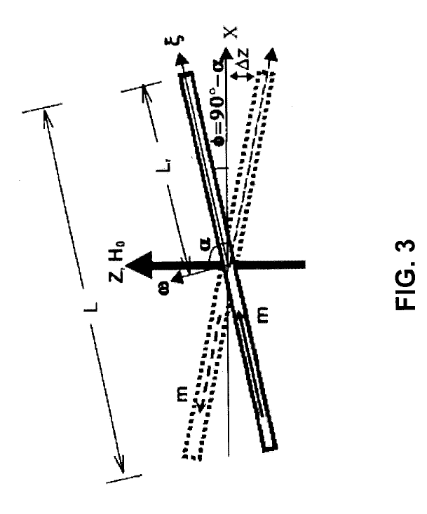

FIG. 3 shows how bi-stability can be produced according to embodiments of the present invention. When the length L of a permalloy cantilever 102 is much larger than its thickness t and width (w, not shown), a direction along its long axis becomes the preferred direction for magnetization (also called the “easy axis”). When such a cantilever is placed in a uniform permanent magnetic field, a torque is exerted on the cantilever. The torque can be either clockwise or counterclockwise, depending on the initial orientation of the cantilever with respect to the magnetic field. In the orientation shown in FIG. 3, when the angle (α) between the cantilever axis (ξ) and the external field (H₀) is smaller than 90°, the torque is counterclockwise; and when a is larger than 90°, the torque is clockwise. The bidirectional torque arises because of the bidirectional magnetization (by H₀) of the cantilever (in the orientation shown in FIG. 3, from left to right when α<90°, and from right to left when α>90°). Due to the torque, the cantilever tends to align with the external magnetic field (H₀). However, when a mechanical force (such as the elastic torque of the cantilever, a physical stopper, etc.) preempts to the total realignment with H₀, two stable positions (“up” and “down”) are available, which forms the basis of latching in the switch.

(ii) Electrical Switching

If the bidirectional magnetization along the easy axis of the cantilever arising from H₀ can be momentarily reversed by applying a second magnetic field to overcome the influence of (H₀), then it is possible to achieve a switchable latching relay. This scenario can be realized by situating a conductor (e.g., a planar coil) proximate (e.g., under or over) the cantilever to produce the required temporary switching field. The planar coil geometry was chosen because it is relatively simple to fabricate, though other structures (e.g., a wrap-around coil, a three dimensional type coil, etc.) can also be used. Also, in alternative embodiments, plural coils can be used. The magnetic field (H_{coil}) lines can be generated by a short current pulse loop around the coil. A ξ-component, which is directed along the cantilever, can be used to reorient the magnetization in the cantilever. The direction of the coil current can determine whether a positive or a negative ξ-field component is generated. After switching, the permanent magnetic field holds the cantilever in this state until the next switching event is encountered. Since the ξ-component of the coil-generated field (Hcoil-ξ) only needs to be momentarily larger than the ξ-component (H₀ξ˜H₀ cos (α)=H₀ sin (φ), α=90°−φ) of the permanent magnetic field and φ is typically very small (e.g., (φ<5°), switching current and power can be very low, which is an important consideration in micro relay design.

For the embodiments described above, the operation principle can be summarized as follows: (1) a permalloy cantilever in a uniform (in practice, the field can be just approximately uniform) magnetic field can have a clockwise or a counterclockwise torque depending on the angle between its long axis (easy axis, L) and the field, (2) two bi-stable states are possible when other forces can balance die torque; and (3) a coil can generate a momentary magnetic field to switch the orientation of magnetization along the cantilever and thus switch the cantilever between the two states.

It is to be appreciated that, although latching micro-magnetic switches are appropriate for RF applications, the switching coils can introduce noise if they are positioned too close to the signal path.

An example of a switch that is similar to the above-described latching micro-magnetic switch is described in international patent publications WO0157899 (titled Electronically Switching Latching Micro-magnetic Relay And Method of Operating Same), and WO0184211 (titled Electronically Latching Micro-magnetic Switches and Method of Operating Same), to Shen et al. These patent publications provide a thorough background on latching micro-magnetic switches, and are incorporated herein by reference in their entirety. Moreover the details of the switches disclosed in WO0157899 and WO0184211 can be applicable to implement the switch of the present invention as described below.

Singe Pole, N Throw Switch (SPNT)

(i) Single Pole, Double Throw Switch

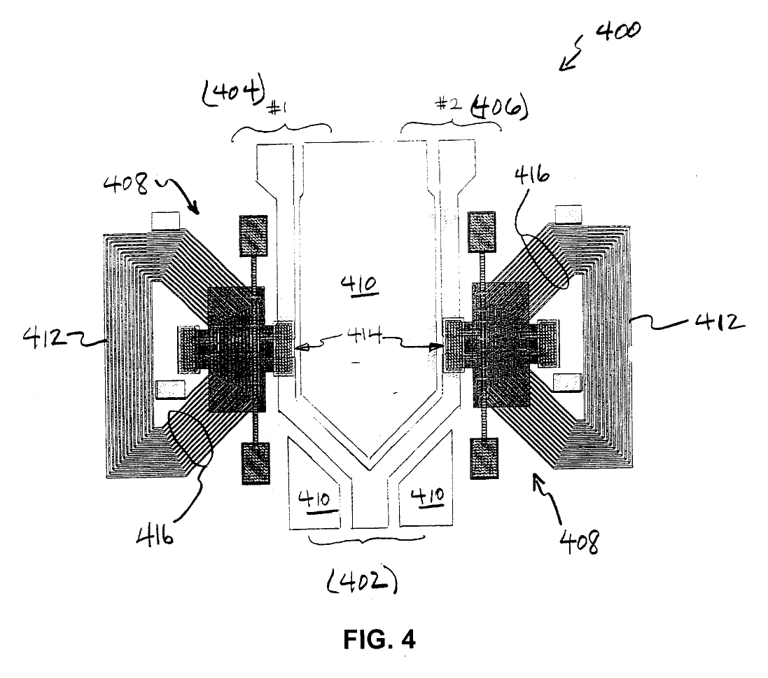

FIG. 4 illustrates a system 400 according to an embodiment of the present invention. System 400 can be an M-in/N-out switching matrix or a single-pole-N-throw (SPNT) switch (where M=1 . . . m and N=1 . . . n). For example, a single-pole-double-throw (SPDT) “Y” type switch configuration, where N=2. In an SPDT mode, an radio frequency (RF) input signal path 402 is routed to a first RF output path 404 and a second RF output path 406 under control of two single-pole-single-throw (SPST) latching micro-magnetic switches 408. System 400 can also include an RF ground conductor 410. Although the system and method are discussed in relation to RF switching, the invention should not be seen as being limited to that environment.

In various embodiments, SPST latching micro-magnetic switches 408 have switching coils 412 that can be formed so they do not overlap the signal paths to avoid introducing noise into propagating RF signal paths. To minimize interference, coil conductors 416 can be routed away from signal paths 402-406. This is shown in the embodiment in FIG. 4 by viewing left switch 408, where the coil routing configuration is that of a letter “D”. It is to be appreciated that other coil routing configurations will be apparent to persons skilled in the relevant art without departing from the spirit and scope of the present invention.

As seen in FIG. 4, switching occurs at locations 414. Elements similar to switches 100 and 200 discussed above and shown in FIGS. 1A-1B and 2 are not labeled for convenience in FIG. 4. Switches 408 each have a cantilever with a conductive contact at locations 414. When one or both of the switches 408 are actuated, its cantilever moves so that the corresponding conductive contact electrically connects the input signal path 402 to the appropriate output signal path (404 and/or 406).

In various embodiments, switch 400 functions in an SPDT mode when both switches 408 electrically connect an input signal path 402 to output signal paths 404 and 406. In alternative embodiments, switch 400 can function in a multiplex mode to electrically connect the input signal path 402 to either of the two output signal paths 404 or 406 through appropriate switching of both switches 408. Other than the specific non-overlap aspect of the coils 412, switches 402 can comprise any of the various types of latching micro-magnetic replays disclosed in the above patent documents, which are incorporated herein by reference.

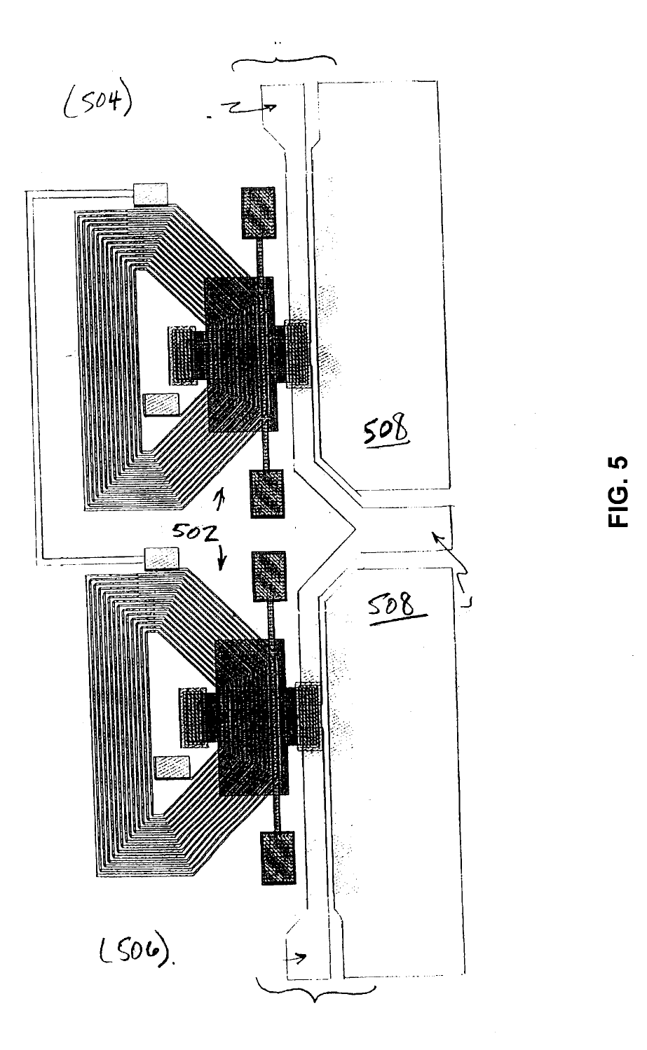

It is to be appreciated that although FIG. 4 shows switches 408 laid-out in an opposed relationship, other orientations are possible. For example, FIG. 5 shows switches 408 laid-out in a side-by-side relationship.

(ii) Single Pole, Four Throw Switch

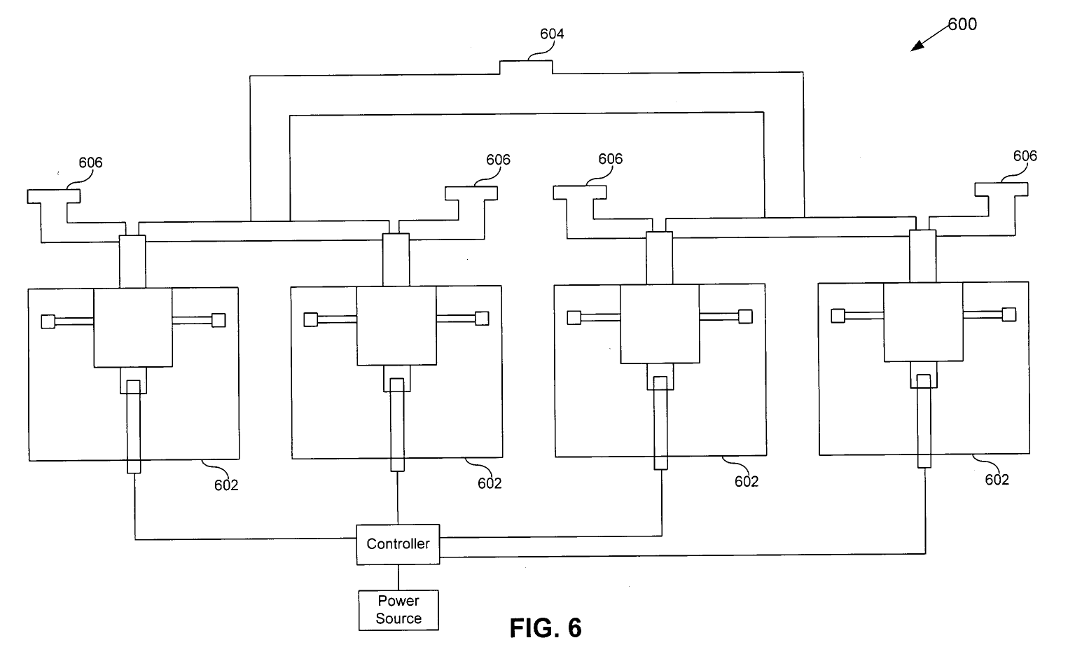

FIG. 6 shows a system (e.g., a single-pole-four-throw (SPFT or SP4T) switch) 600 according to an embodiment of the present invention. Thus, in this embodiment, N=4. System 600 can include four SPST latching micro-magnetic switches 602 that can be used to control transmission of an input signal received at input node 604 of an input section to an output section that can have four nodes 606. Functioning of switches 602 is similar as that described above with reference to FIGS. 1-5. Thus, in various embodiments, either all or some of output nodes 606 can be coupled to input node 604 at one time. This can be accomplished through use of a controller 608 coupled between a power source 610 and conductor contact 612. Controller 608 can be any one of discrete, integrated, or computerized control system, or the like.

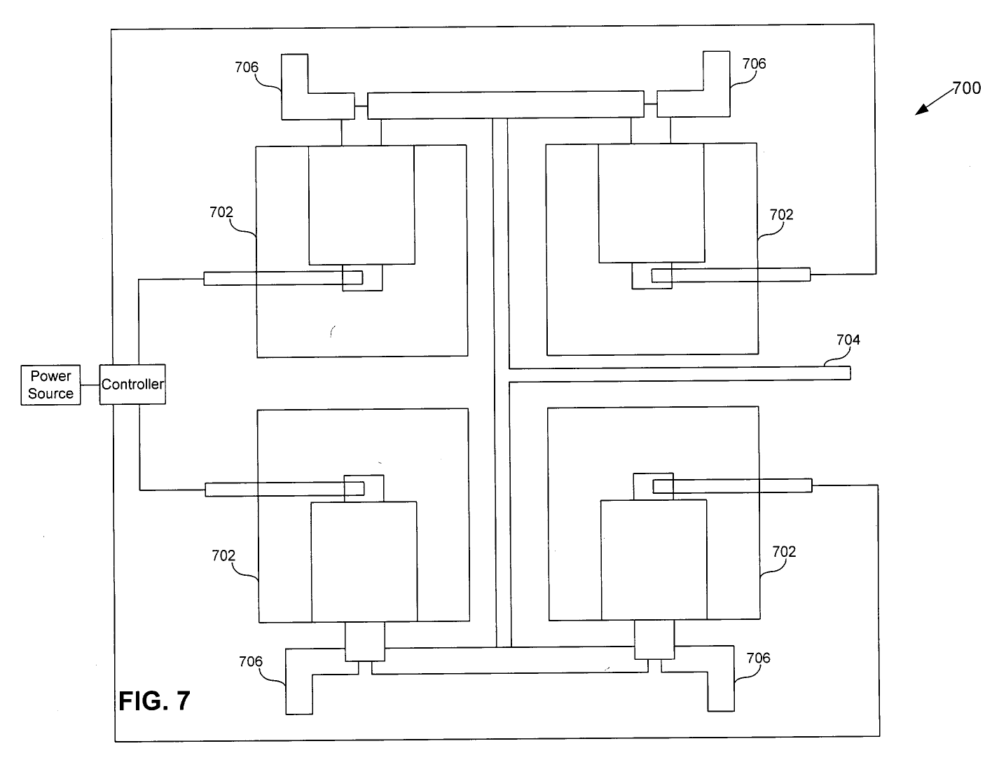

FIG. 7 shows a system (e.g., a single-pole-four-throw (SPFT or SP4T) switch) 700 according to an embodiment of the present invention. Thus, in this embodiment N=4. System 700 can include four SPST latching micro-magnetic switches 702 that can be used to control transmission of an input signal received at input node 704 of an input section to an output section that can have four nodes 706. Functioning of switches 702 is similar as that described above with reference to FIGS. 1-6. Thus, in various embodiments, either all or some of output nodes 706 can be coupled to input node 704 at one time. This can be accomplished through use of a controller 708 coupled between a power source 710 and conductor contact 712. Controller 708 can be any one of discrete, integrated, or computerized control system, or the like.

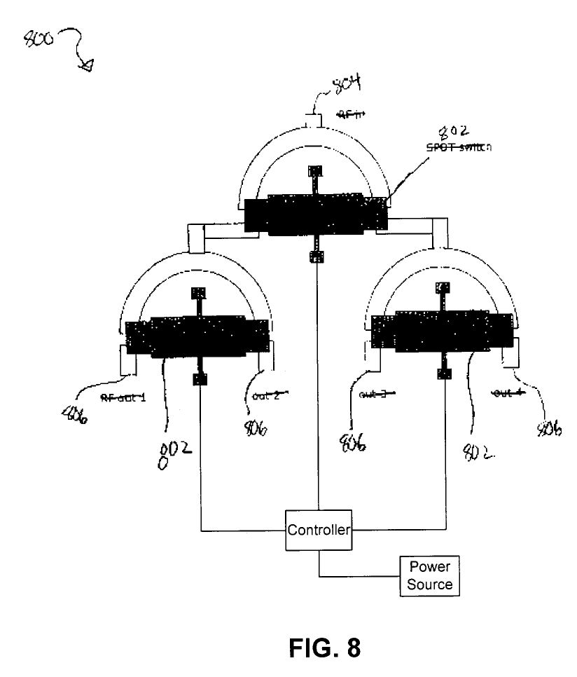

FIG. 8 shows a system (e.g., a single-pole-four-throw (SPFT or SP4T) switch) according to an embodiment of the present invention. Thus, in this embodiment, N=4. System 800 can include three SPDT latching micro-magnetic switches 802 that can be used to control transmission of an input signal received at input node 804 of an input section to an output section that can have four nodes 806. Functioning of switches 802 is similar as that described above with reference to FIGS. 1-7. Thus, in various embodiments, either all or some of output nodes 806 can be coupled to input node 804 at one time. This can be accomplished through use of a controller 808 coupled between a power source 810 and conductor contact 812. Controller 808 can be any one of discrete, integrated, or computerized control system, or the like.

In other alternative embodiments, a combination of FIGS. 4 and 5 can yield a SPFT (e.g., a 1×4) switch by laying-out a mirror image of switches 502 and RF output paths 504/504 on the opposite side of RF ground paths 508.

Conclusion

The corresponding structures, materials, acts and equivalents of all elements in the claims below are intended to include any structure, material or acts for performing the functions in combination with other claimed elements as specifically claimed. Moreover, the steps recited in any method claims may be executed in any order. The scope of the invention should be determined by the appended claims and their legal equivalents, rather than by the examples given above. Finally, it should be emphasized that none of the elements or components described above are essential or critical to the practice of the invention, except as specifically noted herein.

What is claimed is:

1. A system comprising:
an input section that receives input signals;
an output section that transmits output signals based on the input signals; and
a switching section that includes switches that control transmission of the input signals from the input section to the output section, the switches including,
a magnet proximate to a substrate,
a cantilever coupled to the substrate and positioned proximate to the magnet, the cantilever coupled to a magnetic material, and
a conductor coupled to the substrate, the conductor conducting a current that induces a first torque in the cantilever.

2. The system of claim 1, wherein:
the magnet produces a first magnetic field,
the magnetic material makes the cantilever sensitive to the first magnetic field and the cantilever is operable to rotate between a first and second state based on the first magnetic field producing a second torque in the magnetic material of the cantilever that maintains the cantilever in the first or second state, and
the first torque is based on a second magnetic field produced by the current being conducted.

3. The system of claim 1, further comprising:
a power source; and
a controller coupled to the power source, wherein the conductor receives current based on the controller to produce the first torque.

4. The system of claim 1, wherein the switching section includes two of the switches.

5. The system of claim 1, wherein the switching section includes four of the switches.

6. The system of claim 1, wherein the output section includes multiple output nodes.

7. The system of claim 1, wherein the output section includes two output nodes.

8. The system of claim 1, wherein the output section includes three output nodes.

9. The system of claim 1, wherein the output section includes four output nodes.

10. The system of claim 1, wherein the switches are configured as single-pole-single-throw (SPST) latching micro-magnetic switches.

11. The system of claim 1, wherein the switches are configured as single-pole-double-throw (SPDT) latching micro-magnetic switches.

12. A method comprising:
receiving an input signal; and
routing the input signal to output sections using latching micro-magnetic switches having a cantilever that moves between a first state and a second state based on a first torque generated by a first magnetic field produced by a magnet and a second torque generated by a second magnetic field produced by current flowing through a conductor.

13. The method of claim 12, further comprising using two of the latching micro-magnetic switches to perform the routing.

14. The method of claim 12, further comprising using four of the latching micro-magnetic switches to perform the routing.

15. The method of claim 12, comprising using SPST latching micro-magnetic switches as the switches.

16. The method of claim 12, comprising using SPDT latching micro-magnetic switches as the switches.

17. The method of claim 12, further comprising the step of controlling power from a power source to a conductor to control the current that produces the second torque.

18. A system comprising:
means for supporting a cantilever;
means for providing a first magnetic field that is substantially perpendicular to a longitudinal axis of the cantilever;
switching means for providing a second magnetic field;
means on the cantilever for causing the cantilever, while in a presence of the first magnetic field, to be in one of a normally on or normally off state; and
control means for activating the switching means to switch the state of the cantilever.

19. A method comprising:
supporting a cantilever;
producing a first magnetic field that is substantially perpendicular to a longitudinal axis of the cantilever;
providing a switch that produces a second magnetic field;
providing a device on the cantilever that causes the cantilever, while in a presence of the first magnetic field, to be in one of a normally on or normally off state; and
activating the switch to switch the state of the cantilever.
